(19) United States
(12) Patent Application Publication
(10) Pub. No.: US 2022/0185588 A1
(43) Pub. Date: Jun. 16, 2022

(54) Hygienic Sprocket Wheel

(71) Applicant: Ammeraal Beltech Modular A/S, Vejle (DK)

(72) Inventor: Kenneth Westergaard Andersen, Vejle (DK)

(21) Appl. No.: 17/432,151

(22) PCT Filed: Feb. 21, 2020
(86) PCT No.: PCT/DK2020/050047

§ 371 Date: Aug. 19, 2021

(30) Foreign Application Priority Data
Feb. 21, 2019 (DK) PA 2019 70112

(51) Int. Cl. B65G 23/06

(52) U.S. Cl. CPC B65G 23/06; B65G 2207/26

(57) ABSTRACT

Sprocket wheel for use in a conveying structure of the type where a conveyor belt is assembled from a plurality of similar modular belt links, where the sprocket wheels are designed to engage, guide and drive the conveyor belt, wherein the sprocket wheel comprises a central area suitable to be arranged and fastened on a drive axle, and a plurality of drive teeth arranged along and projecting from the periphery of the central area of the sprocket wheel, wherein said sprocket wheel has a peripheral surface area between adjacent drive teeth, where at most 15% preferably only 10% or less of said peripheral surface area in use is in engagement with the conveyor belt.

### FIELD OF THE INVENTION

The present invention relates to a hygienic sprocket wheel for use with conveyors of the type where the conveyor belt is made up from a plurality of substantially identical modular belt links.

### BACKGROUND OF THE INVENTION

These types of conveyor belts are used in a wide variety of industries, but particularly when used in food processing the requirements to hygiene and the ability to be able to clean the conveyor structure including the conveyor belt and the underlying structure are very high and as such it is desirable already at the design phase to take into account the types of products which are to be handled by the conveyor and furthermore to also design the conveyor structure in such a manner that it is possible to obtain the high hygienic standard which is required by handling of food stuffs.

In a traditional conveyor structure the conveyor belt, when the conveyor belt is of the type assembled from a large number of substantially identical modular belt links, is driven by sprocket wheels arranged underneath the surface of the conveyor belt, i.e. the conveying surface, where the sprocket wheels engage notches, recesses or ridges provided on the rear side of the modular belt links for this purpose.

The sprocket wheels are typically arranged on a drive axle such that by rotating the drive axle the sprocket wheels will rotate and by the interface between the teeth provided on the periphery of the sprocket wheels the engagement between the teeth and the conveyor belt will propel the conveyor belt and thereby the objects placed on the conveyor. At the same time the periphery of the sprocket wheel between adjacent teeth will carry/support the conveyor belt.

Particularly in the drive section, i.e. the section of the conveying structure comprising the motor propelling the drive axle and the engagement between the drive axle and the sprocket wheel and the engagement between the sprocket wheels and the underside of the conveyor belt are places which are difficult to clean by ordinary measures and as such there is a risk that unwanted matter or debris accumulate in this region and thereby give rise to pollution of the foodstuff being handled by the conveyor structure. In addition to being difficult to reach for cleaning purposes, these sprocket wheels may also be difficult to inspect, service and replace.

In WO2013/126307 is disclosed a sprocket wheel where a drive axle is designed to engage the sprocket wheel and where the central aperture has a very minimal engagement area with the drive axle. Naturally the area needs to be sufficient in order to transfer torque from the axle to the sprocket wheel. Due to the large open areas of the sprocket wheel according to WO2013/126307 the power transmission is limited. Furthermore, the open areas may retain debris, and such actually proves to have a negative effect.

### OBJECT OF THE INVENTION

Consequently, it is an object of the present invention to provide a sprocket wheel which is designed such that it makes it easier to clean in these difficult places, particularly in the interface between the underside of a conveyor belt and the drive teeth provided on the periphery of the sprocket wheel.

### DESCRIPTION OF THE INVENTION

The present invention addresses this by providing a sprocket wheel for use in a conveying structure of the type where a conveyor belt is assembled from a plurality of similar modular belt links, where the sprocket wheels are designed to engage, guide and drive the conveyor belt, wherein the sprocket wheel comprises a central area suitable to be arranged and fastened on a drive axle, and a plurality of drive teeth arranged along and projecting from the periphery of the central area of the sprocket wheel, wherein said sprocket wheel has a peripheral surface area between adjacent drive teeth, where at most 15% preferably only 10% or less of said peripheral surface area in use is in engagement with the conveyor belt.

By minimizing the engagement between the conveyor belt and the sprocket wheel, less debris may be accumulated on the sprocket wheel as such and furthermore less debris may be forced into the structure of the conveyor belt, for example in the slits and recesses provided between adjacent modular belt links or in the belt links themselves, for example by being forced in due to the pressure between the drive teeth of the sprocket wheel and the modular conveyor belt as such.

Particularly for conveyor belts having a very open surface the minimized engagement between the sprocket wheel, particularly the periphery of the sprocket wheel and the underside of the conveyor belt, facilitates that also liquids (blood, cleaning water etc.) and other debris being transported on top of the conveying surface may pass the conveyor belt and not come into contact or rest on the sprocket wheel as such, but may be easily flushed off the sprocket wheel during operation.

In a further advantageous embodiment of the invention the drive teeth arranged along and projecting from the periphery of the central area of the sprocket wheel has a distal end furthest from the central area, where each tooth has a seating surface connecting to the distal end, where said seating surface has a lower section radially distanced inwards towards the central area relative to the distal end and said lower end of the seating surface projecting forwards in the intended rotation direction, such that the modular belt link will be carried on the seating surface not engaging the peripheral surface between adjacent teeth.

The seating surface foresees that the modular belt link's engagement with the sprocket wheel is retained on the seating surface and as such the modular belt conveyor does not come into contact with the periphery of the central area whereby it is only the engagement between the seating surface and the conveyor belt where any foreign debris may be lodged. Furthermore, by designing the drive teeth with oblique surfaces it is achieved that debris will be forced off the sprocket wheel during the engagement with the underside of the modular belt.

In a still further advantageous embodiment the periphery between adjacent drive teeth comprises cut-outs, such that the distance between the centre of the sprocket wheel and the closest part of the cut-out with respect to the centre is less than the distance between the centre of the sprocket wheel and the periphery.

In this embodiment a larger distance is provided between the modular conveyor belt and the sprocket wheel such that it is relatively easy to thoroughly clean the engagement zone between the sprocket wheel and the conveyor belt thereby achieving the high standard of hygiene.

In a still further advantageous embodiment of the invention a ridge or crest is arranged projecting from the peripheral surface, between adjacent drive teeth, such that the underside of the conveyor belt may engage said crest or ridge whereby in use the crest or ridge minimizes the engagement area or contact surface between the sprocket wheel and the conveyor belt.

In fact, the ridge or crest elevates the conveyor belt in the engagement zone such that the conveyor belt actually rests on the crest or ridge.

In one embodiment the ridge or crest is arranged along the periphery of the central area. In this configuration the ridge or crest will be able to support a multitude of different modular belt links regardless of their rear surface in that the peripheral extent, i.e. the extending between adjacent teeth on the periphery of the sprocket wheel ensures that it will be possible to provide the support for the conveyor belt when engaged with the sprocket wheel.

In an alternative embodiment the ridge or crest is arranged orthogonal to the periphery of the central area. In this embodiment the ridge or crest may have a very small extent along the circumference of the sprocket wheel but will be able to at least provide a “point” support for the conveyor belt and as such elevate the underside of the conveyor belt from the sprocket wheel sufficiently in order to provide an easy cleaning.

In a further advantageous embodiment of the invention the sprocket wheel is in two or more sections, where the two or more sections may be assembled around the axle, forming a complete circumference with the projecting teeth substantially evenly spaced along the periphery.

In many applications, particularly for wider conveyor belts, a plurality of sprocket wheels is arranged on the same axle laterally with respect to the conveying direction of the conveyor belt. If one sprocket wheel fails, i.e. teeth break off or altogether cracks, it is possible to dismount the two parts sprocket wheel from the axle without removing the other sprocket wheels and position a new complete sprocket wheel in its correct position. In this manner the downtime of the entire conveyor structure may be minimized and repairs are fairly easy to carry out.

In a further advantageous embodiment of the invention an aperture is provided centrally in the central area, said aperture allowing the drive axle to pass through the sprocket wheel, where the inner periphery of the aperture is provided with axle engagement sections separated by cut-outs, not adapted to engage the drive axle.

This aperture is traditionally used in order to fit the axle in order to be able to transfer torque from the axle to the sprocket wheel a close and fitting engagement must be provided between the sprocket wheel and the axle. In this embodiment the engagement sections of the sprocket wheel are discreet and separated by cut-outs such that openings are provided between the surface of the axle and parts of the sprocket wheel. In this manner it is possible to flush and wash effectively along the axle except where the engagement zone is in firm engagement with the drive axle. In some embodiments the engagement zones will be reinforced, i.e. the material thickness will be increased in order to absorb the torque forces transferred from the drive axle to the sprocket wheel.

In order to be able to assemble the multi-part sprocket wheel around the drive axle the sprocket wheel in a further advantageous embodiment is in two or more sections, each section having two substantially radial diverging sides connecting the periphery to an aperture provided centrally in the central area said aperture allowing the drive axle to pass through the sprocket wheel, where adjacent radial diverging sides means are provided for assembling adjacent sections around the drive axle.

### DESCRIPTION OF THE DRAWING

The invention will now be described with reference to the accompanying drawings wherein

FIG. 1 illustrates an end section of a conveying structure

FIG. 2 illustrates a prior art sprocket wheels

FIG. 3 illustrates a prior art sprocket wheel

FIG. 4 illustrates a sprocket wheel according to the invention in the two part form

FIG. 5 illustrates the embodiment of FIG. 4 is illustrated in a side-view

FIG. 6 illustrates a close-up of the engagement between the conveyor belt and the sprocket wheel

FIG. 7 illustrates an embodiment of the present invention

FIG. 8 illustrates an embodiment of the present invention

FIG. 9 illustrates an embodiment of the present invention

FIG. 10 illustrates a cross-section through a part of a sprocket wheel

FIG. 11 illustrates the ridge or crest arranged perpendicular to the plane of the sprocket wheel

### DETAILED DESCRIPTION OF THE INVENTION

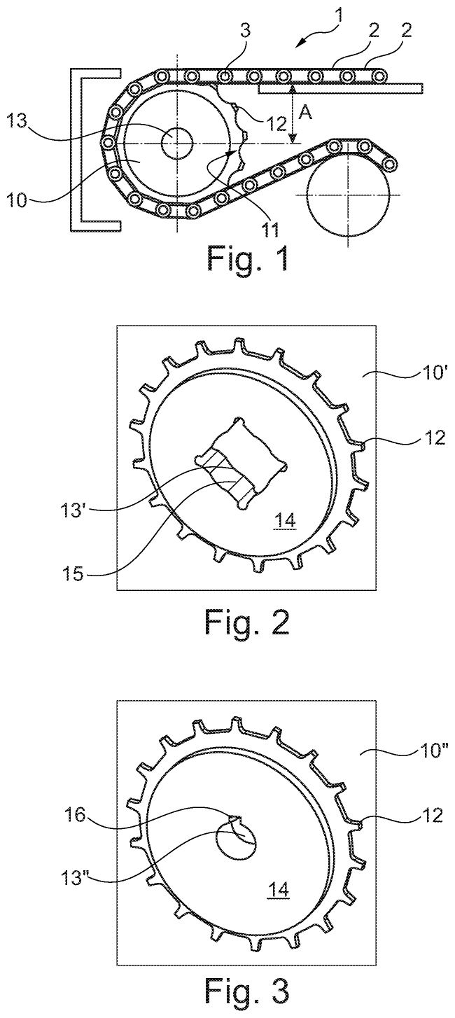

In FIG. 1 is schematically illustrated an end section of a conveying structure, said conveying structure comprising a conveyor belt 1 assembled from a plurality of substantially identical modular belt links 2. The modular belt links 2 are assembled in a hinge-like fashion by inserting a pin 3 interconnecting adjacent belt links, such that the modular belt links 2 may articulate around the pin, for example when being curved/bent around a sprocket wheel.

The end of the conveying structure is provided with a sprocket wheel 10 where the sprocket wheel along a periphery 11 is provided with guide teeth 12. In this connection the periphery shall be understood as an outer circumference of the sprocket wheel 10 from which drive teeth 12 project substantially radially away from the centre of the sprocket wheel. In the centre of the sprocket wheel 10 is provided an aperture 13 through which aperture 13 an axle either a drive axle or just a rotating axle may be fitted in order to allow the sprocket wheel 10 to rotate around the axle 13.

The distance between adjacent drive teeth 12 is designed such that the drive teeth 12 will engage into recesses provided in the underside of a conveyor belt 1 and an edge of the drive teeth 12 will engage an engagement point/face provided in the conveyor belt 1 in order to propel the conveyor belt.

In FIGS. 2 and 3 are illustrated prior art sprocket wheels 10′, 10″ where both sprocket wheels 10′, 10″ are provided with drive teeth 12 substantially evenly distributed along the periphery of the sprocket wheel 10′, 10″. The material thickness of the sprocket wheels provides for a periphery surface, i.e. the surface of the periphery connecting the two side faces 14, 14′ only one side surface 14 is visible. In a central part of the sprocket wheel 10′, 10″ is provided an aperture 13′, 13″. As is the case already explained above with reference to FIG. 1 the apertures 13′, 13″ serve to fit the sprocket wheel 10 onto a drive axle. In order to transfer the drive forces, i.e. the torque from the not-illustrated axle to the sprocket wheel 10′, 10″ the sprocket wheel 10′ is provided with a square aperture such that a square axle fitted inside the aperture 13′ will engage and transfer torque forces to the inner sides 15 of the aperture 13′.

In the embodiment illustrated in FIG. 3 the aperture 13″ is circular and the axle which will transfer torque forces to the sprocket wheel 10″ is provided with a groove such that a wedge may be inserted in the groove in the axle (not illustrated) and at the same time engage the groove 16 provided in the sprocket wheel. In this manner torque forces are transferred from the axle fitted in the aperture 13″ via the wedge to the sprocket wheel 10″.

In the embodiments illustrated with reference to FIGS. 1, 2 and 3 the drive teeth 12 fit inside an aperture provided in the conveyor belt, such that one side face of the drive tooth will engage the conveyor belt and thereby transfer the force to the conveyor belt which is then moved.

Between two drive teeth 12 is a substantially flat periphery surface which will support the conveyor belt as the conveyor belt is turned around the sprocket wheel.

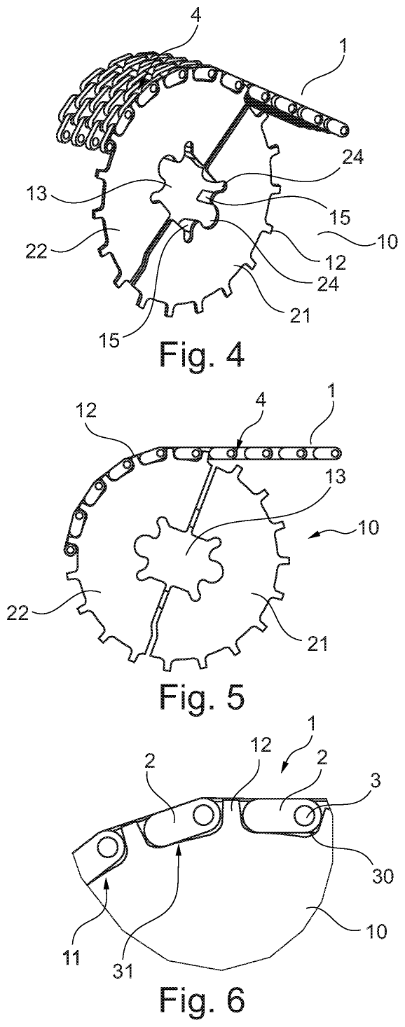

With reference to FIG. 4-6 an embodiment of the present invention will be explained.

In FIG. 4 a sprocket wheel according to the invention, in this embodiment in the two part form comprising two sections 21, 22 is illustrated. Along the periphery of the sprocket wheel 10 are substantially evenly spaced drive teeth and as may be seen in FIG. 4 a conveyor belt 1 is arranged on the sprocket wheel 10 such that the drive teeth are inserted into apertures 4 in the conveyor belt.

As the sprocket wheel 10 is rotated, the drive teeth 12 will engage the conveyor belt and thereby propel the conveyor as explained above. In FIG. 5 the embodiment of FIG. 4 is illustrated in a side-view where it is obvious that the drive teeth 12 are inserted in apertures 4 created in the conveyor belt 1.

In this embodiment the central aperture 13 has a general square cross section, however, a number of cut-outs 24 are provided such that the engagement surfaces 15 are kept at a minimum, but are slightly reinforced, i.e. have a larger width than the sprocket wheel itself in order to be able to absorb the torque forces delivered by the drive axle (not illustrated). The cut-outs and the limited engagement surfaces 15 provide the possibility of being able to clean thoroughly around the central aperture 13 in order to achieve the high hygienic standards.

With reference to FIGS. 6 and 9 one embodiment of the inventive concept of the invention is illustrated. FIG. 6 is a close-up of the engagement between the conveyor belt and the sprocket wheel as seen in FIG. 5. The periphery 11 of the sprocket wheel 10 is provided with a ridge 30 extending from the periphery surface 31. In this context as already mentioned above the periphery surface 31 shall be understood as the surface of the periphery between two drive teeth 12. The ridge 30 causes the engagement with the modular conveyor belt link 2 to be elevated from the main part of the periphery surface and therefore allows for cleaning of a large part of the periphery surface even during engagement with the modular belt links 2.

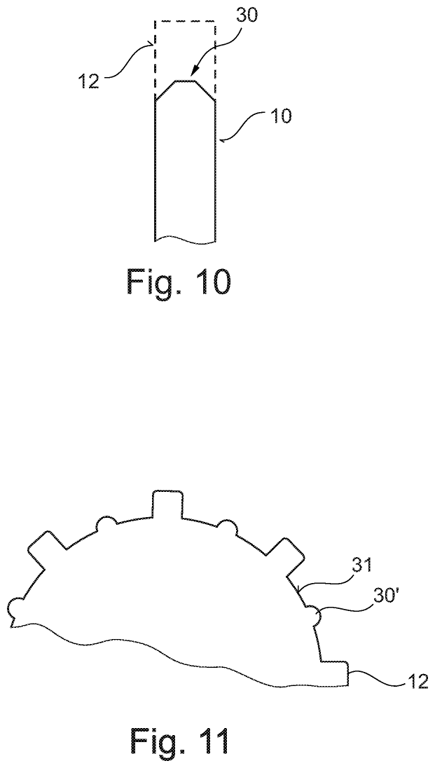

In FIG. 10 is schematically illustrated a cross-section through a part of a sprocket wheel 10 where the ridge or crest 31 is clearly indicated. A drive tooth 12 is illustrated in dashed lines.

It is clear that if the ridge or crest 31 is arranged perpendicular to the plane of the sprocket wheel 10 as illustrated in FIG. 11 by the ridge or crest 31′ the same effect is achieved, i.e. that the modular conveyor belt link 2 as illustrated in FIG. 6 is elevated slightly from the main part of the periphery surface 31.

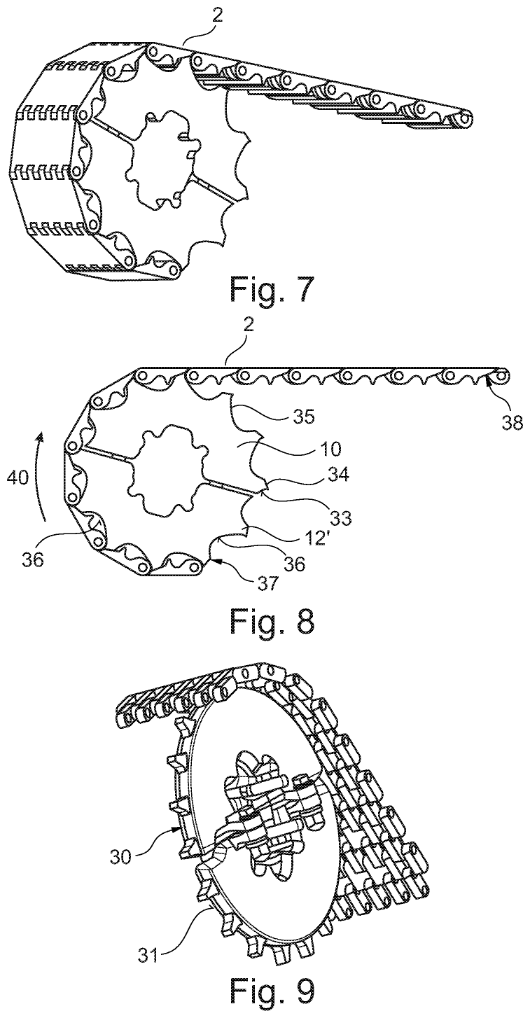

In a further embodiment of the invention as illustrated in FIGS. 7 and 8 the drive teeth arranged along and projecting from the periphery 11 of a central area of the sprocket wheel 10 are arranged such that each drive tooth 12′ has a seating surface 33 connecting to the distal end 34 of the drive tooth. The seating surface 33 has a lower section 35 projecting in the circumferential direction in the direction of the intended rotation direction as indicated by arrow 40, relative to the distal end 34 and the lower end of the seating surface 33.

The seating surface is facing forwards in the intended rotation direction as indicated by the arrow 40. In this manner, as illustrated in FIGS. 7 and 8 the modular belt links 2 will be carried on the seating surface. As further illustrated in FIGS. 7 and 8 the periphery between adjacent drive teeth 12′ are provided with cut-outs in order to create larger openings between the conveyor belt 1 and the sprocket wheel 10 whereby easier cleaning may be achieved. In this particular embodiment illustrated in FIGS. 7 and 8 the drive teeth 12′ are further designed such that a top surface 37 is complementary to an under-surface 38 of the modular belt links 2.

This, however, is a special embodiment where the particular sprocket wheel 10 is specifically designed to the modular belt link 2. In other cases the modular belt modules will only be carried on seating surface as explained above.

1. Sprocket wheel for use in a conveying structure of the type where a conveyor belt is assembled from a plurality of similar modular belt links, where the sprocket wheels are designed to engage, guide and drive the conveyor belt, wherein the sprocket wheel comprises a central area comprising an aperture, suitable to be arranged and fastened on a drive axle, where the inner periphery of the aperture is provided with axle engagement sections separated by cut-outs, not adapted to engage the drive axle, and where a plurality of drive teeth are arranged along and projecting from the periphery of the central area of the sprocket wheel, wherein said sprocket wheel has a peripheral surface area between adjacent drive teeth, where at most 15% preferably only 10% or less of said peripheral surface area in use is in engagement with the conveyor belt and where the sprocket wheel is in two or more sections, where the two or more sections may be assembled around the axle, forming a complete circumference with the projecting teeth substantially evenly spaced along the periphery.

2. Sprocket wheel according to claim 1, wherein the drive teeth arranged along and projecting from the periphery of the central area of the sprocket wheel has a distal end furthest from the central area, where each drive tooth has a seating surface connecting to the distal end, where said seating surface has a lower section radially distanced inwards towards the central area relative to the distal end and said lower end of the seating surface projecting forwards in the intended rotation direction, such that the modular belt link will be carried on the seating surface not engaging the peripheral surface between adjacent teeth.

3. Sprocket wheel according to claim 2, wherein the periphery between adjacent drive teeth comprises cut-outs, such that the distance between the centre of the sprocket wheel and the closest part of the cut-out with respect to the centre is less than the distance between the centre of the sprocket wheel and the periphery.

4. Sprocket wheel according to claim 1, wherein a ridge or crest is arranged projecting from the peripheral surface, between adjacent drive teeth, such that the underside of the conveyor belt may engage said crest or ridge whereby in use the crest or ridge minimizes the engagement area or contact surface between the sprocket wheel and the conveyor belt.

5. Sprocket wheel according to claim 4, wherein said ridge or crest is arranged along the periphery of the central area.

6. Sprocket wheel according to claim 4, wherein said ridge or crest is arranged orthogonal to the periphery of the central area.

7. Sprocket wheel according to claim 1 where, when the sprocket wheel is in two or more sections, each section has two substantially radial diverging sides connecting the periphery to an aperture provided centrally in the central area said aperture allowing the drive axle to pass through the sprocket wheel, where adjacent radial diverging sides means are provided for assembling adjacent sections around the drive axle.
